(19) United States
(12) Patent Application Publication
(10) Pub. No.: US 2021/0247489 A1
(43) Pub. Date: Aug. 12, 2021

(54) AUTOMOTIVE RADAR WITH COMMON-DIFFERENTIAL MODE ANTENNA

(71) Applicant: Alps Alpine Co., Ltd., Tokyo (JP)

(72) Inventors: Alebel H. ARAGE, Lake Orion, MI (US); Kubilay SERTEL, Hilliard, OH (US); Niru K. NAHAR, Hilliard, OH (US)

(21) Appl. No.: 16/785,102

(22) Filed: Feb. 7, 2020

(51) Int. Cl. G01S 7/35; G01S 13/04; G01S 7/03; G01S 13/931

(52) U.S. Cl. CPC G01S 7/352; G01S 13/931; G01S 7/032; G01S 13/04

(57) ABSTRACT

A radar sensor system includes transmit circuitry configured to provide a source signal to first and second transmit antenna slots, selectively shift a phase of the source signal as provided to the second transmit antenna slot relative to the source signal as provided to the first transmit antenna slot, and output transmit signals based on the source signal provided to the first and second antenna slots. Receive circuitry is configured to receive, via first and second receive antenna slots, reflected signals corresponding to the transmit signals as reflected from an object in the environment. A control module is configured to, in a first antenna pattern mode, sum the reflected signals, and, in a second antenna pattern mode, calculate a difference between the reflected signals. The radar sensor system is configured to detect the object based on the sum of the reflected signals and the calculated difference between the reflected signals.

### FIELD

The present disclosure relates to radar sensors for vehicle safety and autonomous vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles may include one or more different type of sensors that sense vehicle surroundings. In some examples, signals received from the sensors may be processed and provided as inputs to autonomous driving systems. Autonomous vehicles are configured to travel on roadways in accordance with data collected and processed via the sensors and/or additional data including, but not limited to, data from a global positioning system, driver inputs, data received from other vehicles, etc. In other examples, the signals received from the sensors may be processed and provided as inputs to control systems configured to alert drivers about obstacle objects detected in the vehicle surroundings. The sensors are arranged on an exterior and/or interior of the vehicle to sense objects such as other vehicles, pedestrians, road infrastructures and/or road hazards, lane markings, traffic signs and lights, etc.

One example of a sensor that senses vehicle surroundings includes a radar sensor. Radar sensors may be configured to operate at micrometer (μm) and millimeter (mm) wave frequency bands providing sufficient resolution for object detection and parameter (e.g., kinematic quantities) measurement. Example frequency bands include, but not limited to, 24 GHz, 77 GHz, 79 GHz, and other higher millimeter frequency bands.

### SUMMARY

A radar sensor system includes transmit circuitry configured to respectively provide a source signal to first and second transmit antenna slots, selectively shift a phase of the source signal as provided to the second transmit antenna slot relative to the source signal as provided to the first transmit antenna slot, and output transmit signals to an environment based on the source signal provided to the first and second antenna slots. Receive circuitry is configured to receive, via first and second receive antenna slots, reflected signals corresponding to the transmit signals as reflected from an object in the environment. A control module is configured to, in a first antenna pattern mode, sum the reflected signals, and, in a second antenna pattern mode, calculate a difference between the reflected signals. The radar sensor system is configured to detect the object based on the sum of the reflected signals and the calculated difference between the reflected signals

A method of operating a radar sensor system includes respectively providing a source signal to first and second transmit antenna slots, selectively shifting a phase of the source signal as provided to the second antenna slot relative to the source signal as provided to the first transmit antenna slot, outputting transmit signals to an environment based on the source signal provided to the first and second antenna slots, receiving, via first and second receive antenna slots, reflected signals corresponding to the transmit signals as reflected from an object in the environment, in a first antenna pattern mode, summing the reflected signals, in a second antenna pattern mode, calculating a difference between the reflected signals, and detecting the object based on the sum of the reflected signals and the calculated difference between the reflected signals.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an example vehicle including radar sensors according to the principles of the present disclosure;

FIG. 2A is a radar sensor system according to the principles of the present disclosure;

FIG. 2B is a differential mode, double slot antenna according to the principles of the present disclosure;

FIGS. 3A and 3B illustrate example azimuth and elevation gain patterns of the common-differential mode antenna according to the principles of the present disclosure;

FIGS. 4A and 4B illustrate example for common-mode antenna gain patterns in an azimuth plane and an elevation plane, respectively;

FIGS. 5A and 5B illustrate example differential-mode antenna gain patterns in an azimuth plane and an elevation plane, respectively; and

FIG. 6 illustrates steps of an example method of operating a radar sensor system according to the principles of the present disclosure.

In the drawings, reference numbers may be reused to identify similar and/or identical elements.

### DETAILED DESCRIPTION

Radar sensors for vehicle safety and autonomous vehicle applications have various performance requirements. Improving performance associated with some requirements may conflict with performance associated with other requirements. For example, detecting smaller objects (i.e., objects having a small Radar signal effective reflection Cross Section, or RCS) at longer detection range coverage may require greater antenna directivity. Increasing antenna directivity further increases angular selectivity (i.e., increases radar image resolution and accuracy). Greater antenna directivity is achieved by increasing an antenna aperture, which conflicts with small sensor size requirements. Consequently, greater antenna directivity corresponds to narrower antenna beamwidth, detecting smaller objects for wider Field-of-View (FOV) coverage is difficult. This means, there will be uncovered (or a blind) zone in the vehicle surroundings between radar sensors installed on the same host vehicle.

Conversely, the antenna aperture can be reduced to increase beamwidth for smaller directivity, and also to reduce the overall radar sensor size. This improves radar FOV coverage and reduces blind zones in the vehicle surroundings between radar sensors in a radar sensor network. However, since this is achieved by trading off directivity, detecting smaller object at longer range becomes difficult. Accordingly, antenna design modifications that result in improved performance with respect to FOV coverage may conflict with performance requirements for antenna directivity (e.g., relatively improved gain, resolution and accuracy) and vice versa.

Various methods may be used to mitigate conflicting performance requirements. In one example, the blind zones between radar sensors are minimized by increasing the number of radar sensors arranged on the vehicle and optimizing respective orientation angles of the radar sensors. However, increasing the number of radar sensors does not eliminate blind zones, increases the cost per vehicle, and may cause interference between closely spaced radar sensors and affect the radar performance.

Radar sensor systems and methods according to the present disclosure implement a radar sensor network including common-differential mode, double slot antennas to maximize both antenna directivity and FOV coverage. Each transmitting common-differential mode antenna includes two antenna slots that transmit signal received from the same source. The source signals received by each of the transmit antenna slots could have the same phases or different phases (e.g., two differential, orthogonal phases). Each receiving common-differential mode antenna is configured to receive, via the two slots, respective from radar target reflected signals corresponding to the transmit signals. Each of the common-differential mode antennas may include a dielectric lens.

In this manner, the common-differential mode antenna is configured to provide two antenna pattern profiles For example, a common antenna pattern profile which is a calculated sum of the reflected signals corresponding to the transmit signals with same signal phases. Conversely, a differential antenna pattern profile, which is a calculated difference of the reflected signals corresponding to transmit signals with orthogonal signal phases.

Accordingly, the radar sensor systems and methods of the present disclosure improve the FOV coverage of a radar sensor network while maintaining high directivity, image resolution and accuracy, and thereby reduce the number of radar sensors required per vehicle.

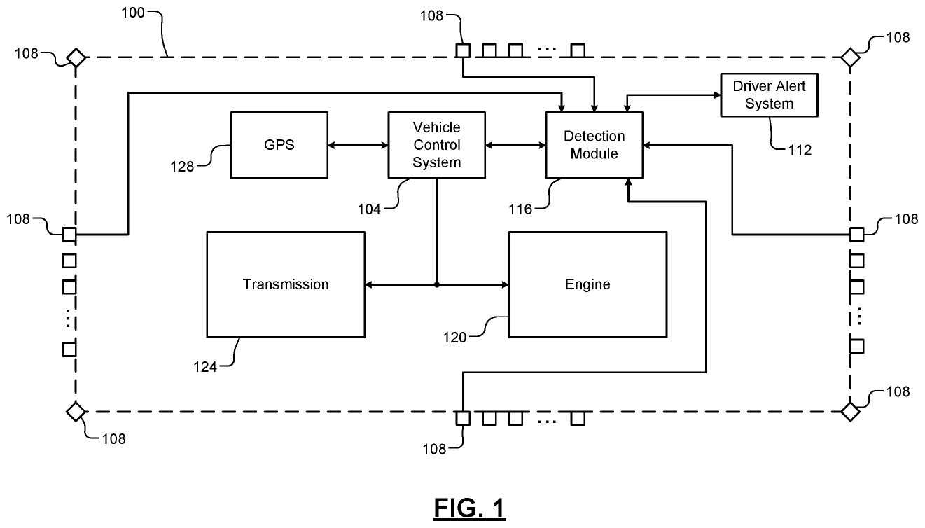

Referring now to FIG. 1, an example vehicle 100 is shown. The vehicle 100 may be a hybrid, non-hybrid, or electric vehicle. In some examples, the vehicle 100 has autonomous or semiautonomous driving capabilities. For example, the vehicle 100 includes a vehicle control system 104 configured to control one or more vehicle functions including, but not limited to, braking, steering, acceleration, transmission (i.e., gear shifting), etc. in accordance with signals received from one or more sensing devices including, but not limited to, radar sensors 108. The radar sensors 108 include as sub-component the common-differential mode, double slot antennas as described below in more detail.

Alternatively or additionally, the vehicle 100 may include a driver alert system 112 responsive to the signals received from the radar sensors 108 and configured to alert a driver of the vehicle 100 about obstacle objects detected in the environment. For example, the driver alert system 112 may be configured to generate audible (e.g., beeping), visual (e.g., flashing lights), and/or haptic (e.g., vibration of interior components of the vehicle) warnings in response to signals indicating potential impact with obstacle objects in the environment.

The radar sensors 108 are arranged in a radar sensor network on a front center, front corner, sides, rear center, rear corner, etc. of the vehicle 100 to detect objects (e.g., other vehicles and/or other objects in the environment). The radar sensors 108 may have any suitable orientation, including, but not limited to, horizontal, vertical, slanted, and circular orientations to operate in accordance with various electromagnetic orientations. The radar sensors 108 transmit signals and receive corresponding from objects reflected signals indicative of the environment in the front, rear, and to the sides of the vehicle 100. A detection module 116 receives the reflected signals and is configured to perform signal processing and other functions related to detection of objects based on the reflected signals. For example, the detection module 116 may be configured to generate images based on the reflected signals, detect and identify features corresponding to objects in the images, provide control signals to the vehicle control system 104 and/or the driver alert system 112 based on the identified features, etc.

The vehicle 100 includes systems including, but not limited to an engine 120 and a transmission 124. The vehicle control system 104 may be configured to selectively control systems of the vehicle 100 via respective control modules (not shown), such as an engine control module, a transmission control module, a braking control module, a steering control module, etc. In some examples, the vehicle 100 includes a global positioning system (GPS) 128 or other type of global navigation satellite system (GNSS) to determine a location of the vehicle 100. In examples where the vehicle 100 has autonomous driving capabilities, the vehicle control system 104 may be configured to provide autonomous control of the vehicle 100 based on vehicle location data received from the GPS 128 in addition to signals received from the radar sensors 108, other sensing sensors (e.g., cameras, Lidar sensors, etc.; not shown), driver inputs, etc.

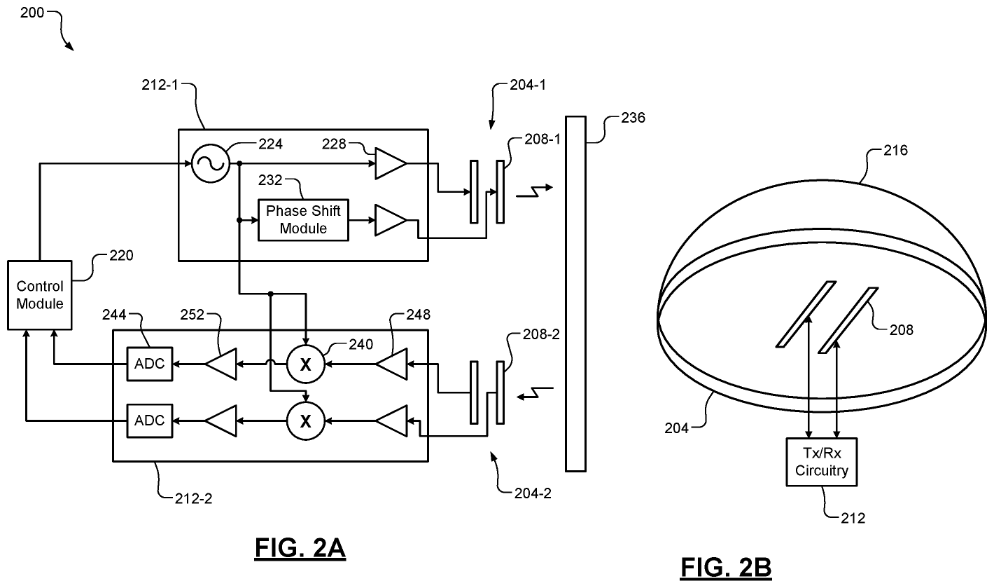

Referring now to FIGS. 2A and 2B, an example radar sensor system 200 according to the principles of the present disclosure includes a network or array of a plurality of common-differential mode, double slot antennas (e.g., corresponding to the radar sensors 108), including a plurality of transmit (Tx) antennas 204-1 and receive (Rx) antennas 204-2, referred to collectively as antennas 204. For example, the radar sensor system 200 may include a plurality of double slot antenna arrays each including one or more double slot antennas. The antenna arrays may correspond to any suitable configuration, including, but not limited to, a Uniform Linear Array (ULA), Planner Linear Array (PLA), Circular Array (CA), etc.

Each of the antennas 204 includes a respective pair of antenna slots 208 (e.g., transmit antenna slots 208-1 and receive antenna slots 208-2). The transmit antenna 204-1 and the receive antenna 204-2 are respectively in communication with the transmit circuitry 212-1 and receive circuitry 212-2, referred to collectively as a transceiver or transceiver (Tx/Rx) circuitry 212. The transceiver (or Tx/Rx) circuitry 212 may further include an impedance matching network (not shown). For illustration purposes, only one transmit antenna 204-1 and receive antenna 204-2 and associated components are shown. In some examples, a single antenna 204 may be used for both transmitting and receiving with circuit modification to add, for example, circulators or switches for guiding transmit and receive signals to a corresponding propagation path.

Each of the antennas 204 is configured to provide two orthogonal, less distorted patterns including a common antenna pattern and a differential antenna pattern. For example, an example antenna 204 as shown in FIG. 2B includes a dielectric lens 216. The lens 216 may be hemispherical or dome-shaped. The hemispherical lens 216 provides wider FOV coverage (e.g., FOV coverage up to 180 degrees) while satisfying performance requirements for directivity that improves radar detection sensitivity and angular resolution and accuracy as described below in more detail.

For example, double slot antenna array elements such as the antennas 204, positioned at a focal plane, provide a diffraction/reflection effect that may be used to control beam directivity in a direction corresponding to reduced reflection from a surface of the lens 216. In one example, control signals may be asymmetrically provided to respective ones of the antennas 204 that are directed away from a focal point corresponding to a target direction. Conversely, an antenna plane of the antenna 204 relative to a focal point of the lens 216 may be positioned to optimize the FOV coverage in an azimuth direction and to adjust elevation patterns in the common antenna pattern and the differential antenna pattern. An example common-differential mode, double slot antenna corresponding to the antennas 204 is described in more detail in U.S. Pat. No. 9,490,280, the entire contents of which are incorporated herein by reference.

Generally, a narrower antenna pattern corresponds to decreased pattern distortion and increased accuracy for object location measurements. The common-differential mode antenna according to the present disclosure provides both common and differential antenna patterns to provide wider FOV coverage with relatively narrower pattern beam width and, therefore, higher directivity and resolution. For example, the wider FOV coverage may be achieved with a first pattern having a wide pattern beam width (e.g., in a first mode), which may have low directivity, low resolution, and pattern distortion leading to inaccurate object location measurements. Conversely, high directivity and increased measurement resolution and accuracy may be achieved with a second pattern.

The radar sensor system 200 includes a control module 220 configured to, for example, provide a control signal to the transmit circuitry 212-1. For example only, the control module 220 may correspond to or be a component of the detection module 116 of FIG. 1. The transmit circuitry 212-1 generates a source signal (e.g., corresponding to a desired transmit signal) in response to the control signal using, for example, a voltage controlled oscillator (VCO) 224. The source signal is provided to respective transmit antenna slots 208-1 (e.g., via respective amplifiers, such as power amplifiers 228) in corresponding transmit signal paths. The transmit signal paths may be implemented using, for example, coplanar waveguide (CPW) feed lines.

A phase shift module 232 arranged in one of the transmit signal paths selectively shifts a phase of the source signal (e.g., by 0 or 180 degrees or any other desired phase shift). Accordingly, the source signal as received by each of the transmit antenna slots 208-1 has a same (e.g., 0 degree difference) phase or two differential, orthogonal (e.g., 180 degree difference) phases. Corresponding transmit signals directed at a radar target (e.g., an object in a FOV of the antenna 204-1) 236 have same or orthogonal phases.

Similarly, reflected signals (i.e., the transmit signals as reflected from the target 236) received at the receive antenna slots 208-2 have same or orthogonal phases. The reflected signals are received at receive signal paths of the receive circuitry 212-2 via respective receive antenna slots 208-2. The receive signal paths may be implemented using CPW feed lines. The reflected signals are provided to mixers 240 configured to combine the reflected signals with the source signal generated by the VCO 224.

Outputs of the mixers 240 (i.e., the mixed reflected signals) are conditioned and provided to the control module 220. For example, the control module 220 may include and/or be configured to function as a digital signal processor (DSP). In some examples, the outputs of the mixers 240 are converted from analog to digital signals using respective analog-to-digital converters (ADCs) 244. The receive circuitry 212-2 may include one or more types of amplifiers (e.g., low noise amplifiers (LNAs) 248 arranged between the receive antenna slots 208-2 and the mixers 240 and/or variable voltage gain amplifiers (VGAs) 252, including bandpass filter, arranged between the mixers 240 and the ADCs 244) configured to filter and amplify the reflected signals.

The control module 220 is configured to generate detection data corresponding to the common antenna pattern and differential antenna pattern using the reflected signals. The control module 200 outputs the detection data to the detection module 116, which is configured to generate images, detect and identify features corresponding to objects in the images, provide control signals to the vehicle control system 104 and/or the driver alert system 112 based on the identified features, etc. based on the detection data.

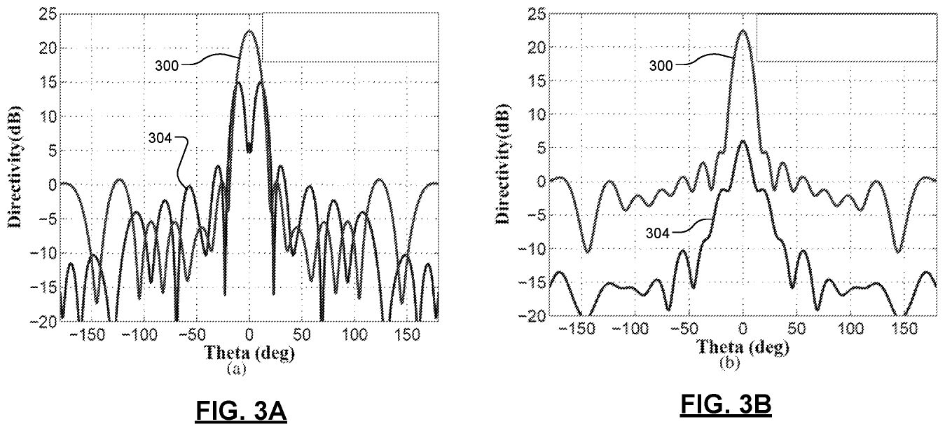

Referring now to FIGS. 3A and 3B and with continued reference to FIGS. 2A and 2B, example common antenna patterns 300 and differential antenna patterns 304 according to the principles of the present disclosure are shown. FIG. 3A shows the common antenna pattern 300 and the differential antenna pattern 304 in the E-plane (e.g., azimuth). FIG. 3B shows the common antenna pattern 300 and the differential antenna pattern 304 in the H-plane (e.g., elevation).

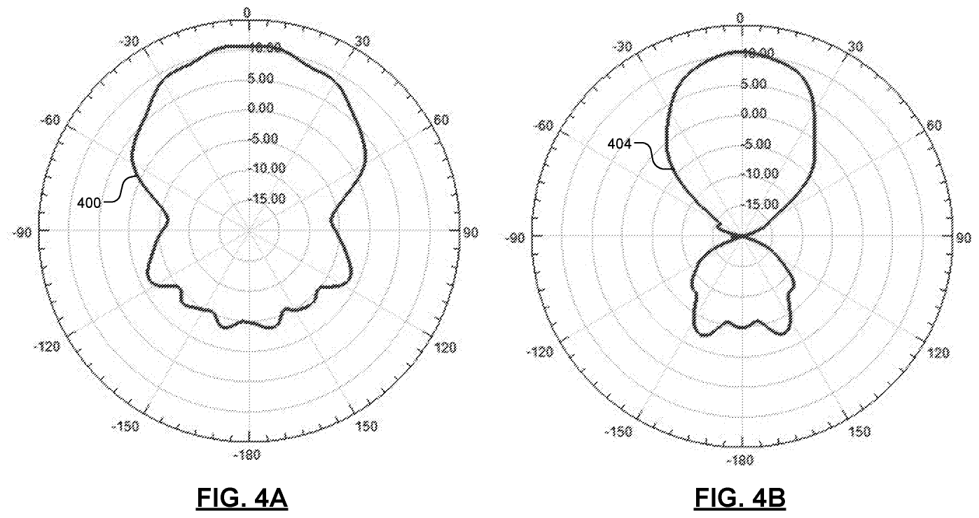

The common antenna pattern 300 is generated by summing (e.g., using the control module 220) the reflected signals respectively received via the receive antenna slots 208-2. For example, the control module 220 sums, in a common antenna pattern mode, the outputs of the ADCs 244 to generate data corresponding to the common antenna pattern 300. The common antenna pattern may correspond to an antenna broadside angle. In the common antenna pattern mode, the phase shift module 232 does not apply a phase shift to the source signal (i.e., a zero phase shift). FIGS. 4A and 4B illustrate example common antenna gain patterns 400 and 404 in an azimuth plane and an elevation plane, respectively, resulting from the summing of the reflected signals having a same phase.

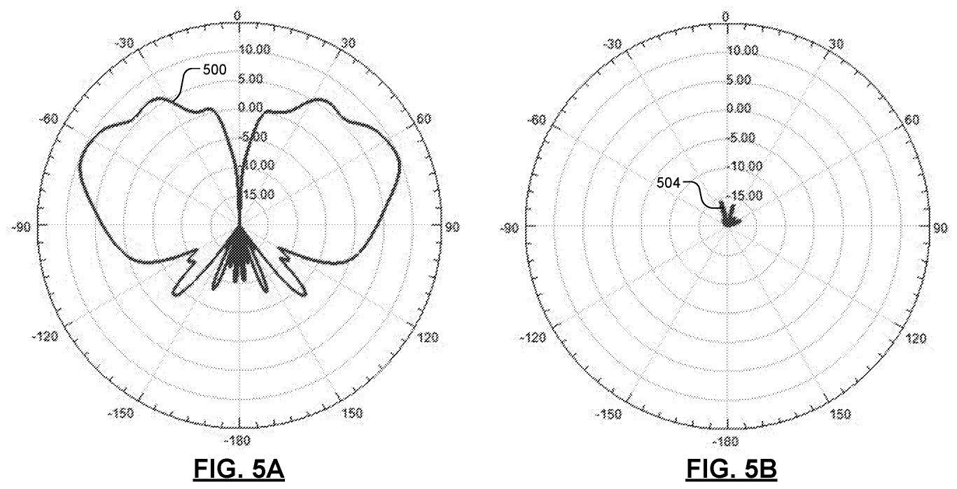

Conversely, the differential antenna pattern 304 is generated by calculating a difference (e.g., using the control module 220) of the reflected signals respectively received via the receive antenna slots 208-2. For example, the control module 220 calculates, in a differential antenna pattern mode, the difference between the outputs of the ADCs 244 (corresponding to the differential reflected signals) to generate data corresponding to the differential antenna pattern 304. The differential antenna pattern corresponds to a pattern with two beams respectively directed to opposite antenna off-broadside angles and including a null at the antenna broadside angle. FIGS. 5A and 5B illustrate example differential antenna gain patterns 500 and 504 in an azimuth plane and an elevation plane, respectively.

The control module 220 is configured to transition between the common and differential antenna pattern modes to respectively generate the common and differential antenna patterns. For example, in the common antenna pattern mode, the control module 220 does not apply a phase shift to the source signal provided to either of the transmit antenna slots 208-1 and sums the reflected signals together to generate the common antenna pattern. Conversely, in the differential antenna pattern mode, the control module 220 applies the phase shift (e.g., a phase shift of 180 degrees) to the source signal as provided to one of the transmit antenna slots 208-1 and calculates the difference between the reflected signals to generate the differential antenna pattern.

The control module 220 is configured to rapidly alternate between the common and differential antenna pattern modes in respective time slots to acquire both the common and differential antenna patterns. In one example, a cycle including a common antenna pattern period and a differential antenna pattern period may correspond to a resolution of the ADCs 244. For example only, alternating samples of the reflected signals provided by the ADCs 244 may include to a sample of the reflected signals in the common antenna pattern mode and a sample of the reflected signals in the differential antenna pattern mode. In this manner, the control module 220 is configured to generate data corresponding to both the common and differential antenna pattern modes for the same reflected signals.

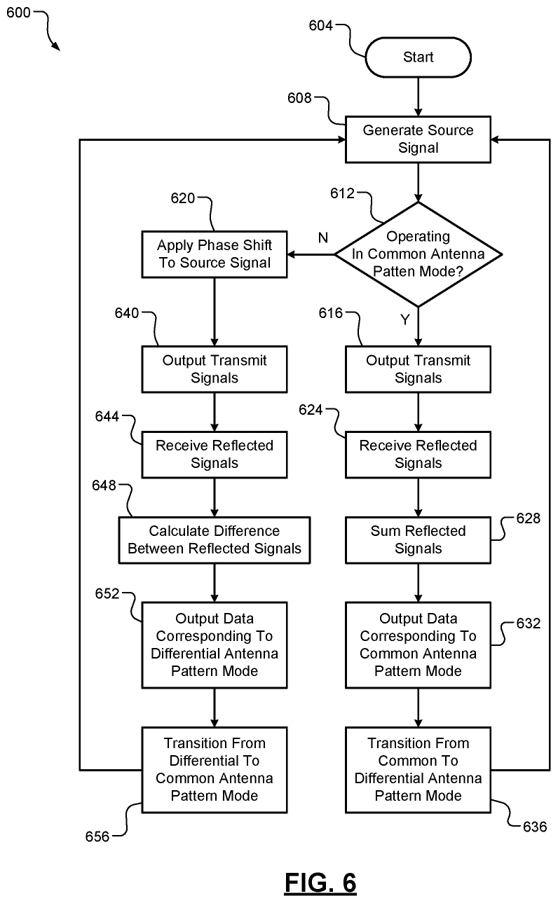

FIG. 6 illustrates steps of an example method 600 of operating a radar sensor system (e.g., the radar sensor system 200) according to the principles of the present disclosure. The method 600 begins at 604. At 608, the method 600 (e.g., the control module 220 and/or the VCO 224) generates a source signal corresponding to a desired transmit signal. At 612, the method 600 (e.g., the control module 220) determines whether the radar sensor system 200 is in the common antenna pattern mode. If true, the method 600 continues to 616. If false, the method 600 continues to 620.

At 616, the method 600 (e.g., the transmit circuitry 212-1) outputs transmit signals using the transmit antenna slots 208-1. At 624, the method 600 (e.g., the receive circuitry 212-2) receives reflected signals at the receive antenna slots 208-2. At 628, the method 600 (e.g., the control module 220) sums the reflected signals. At 632, the method 600 (e.g., the control module 220) outputs data corresponding to a common antenna pattern in accordance with the sum of the reflected signals. At 636, the method 600 (e.g., the control module 220) transitions from the common antenna pattern mode to the differential pattern mode and continues to 608.

At 620, the method 600 (e.g., the phase shift module 232) applies a phase shift to the source signal as provided to one of the transmit antenna slots 208-1. At 640, the method 600 (e.g., the transmit circuitry 212-1) outputs differential transmit signals using the transmit antenna slots 208-1. At 644, the method 600 (e.g., the receive circuitry 212-2) receives reflected signals at the receive antenna slots 208-2. At 648, the method 600 (e.g., the control module 220) calculates a difference between the reflected signals. At 652, the method 600 (e.g., the control module 220) outputs data corresponding to a differential antenna pattern in accordance with the difference of the reflected signals. At 656, the method 600 (e.g., the control module 220) transitions from the differential antenna pattern mode to the common pattern mode and continues to 608.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A radar sensor system, comprising:
transmit circuitry configured to
respectively provide a source signal to first and second transmit antenna slots,
selectively shift a phase of the source signal as provided to the second transmit antenna slot relative to the source signal as provided to the first transmit antenna slot, and
output transmit signals to an environment based on the source signal provided to the first and second antenna slots;
receive circuitry configured to receive, via first and second receive antenna slots, reflected signals corresponding to the transmit signals as reflected from an object in the environment; and
a control module configured to
in a first antenna pattern mode, sum the reflected signals, and
in a second antenna pattern mode, calculate a difference between the reflected signals,
wherein the radar sensor system is configured to detect the object based on the sum of the reflected signals and the calculated difference between the reflected signals.

2. The radar sensor system of claim 1, wherein the transmit circuitry includes a voltage controlled oscillator configured to generate the source signal.

3. The radar sensor system of claim 1, wherein the transmit circuitry includes a phase shift module configured to shift the phase of the source signal in the second antenna pattern mode.

4. The radar sensor system of claim 3, wherein the phase shift module is configured to shift the phase of the source signal by 180 degrees.

5. The radar sensor system of claim 3, wherein the transmit signals are differential signals and the second antenna pattern mode is a differential antenna pattern mode.

6. The radar sensor system of claim 1, wherein the receive circuitry includes mixers configured to respectively combine the reflected signals with the source signal.

7. The radar sensor system of claim 1, further comprising analog-to-digital converters configured to convert the reflected signals to digital signals.

8. The radar sensor system of claim 1, wherein the control module is configured to alternate between the first antenna pattern mode and the second antenna pattern mode.

9. The radar sensor system of claim 1, wherein the first antenna pattern mode corresponds to a common antenna pattern mode and wherein, in the common antenna pattern mode, the transmit circuitry does not shift the phase of the source signal as provided to the second transmit antenna slot.

10. The radar sensor system of claim 1, wherein the second antenna pattern mode corresponds to a differential antenna pattern mode and wherein, in the differential antenna pattern mode, the transmit circuitry shifts the phase of the source signal as provided to the second transmit antenna slot.

11. The radar sensor system of claim 1, further comprising a first double slot antenna including the first and second transmit antenna slots and a second double slot antenna including the first and second receive antenna slots.

12. The radar sensor system of claim 11, wherein each of the first and second double slot antennas includes a dielectric lens.

13. The radar sensor system of claim 12, wherein the dielectric lens is dome-shaped.

14. The radar sensor system of claim 1, further comprising a plurality of double slot antenna arrays, wherein each of the plurality of double slot antenna arrays includes at least one first double slot antenna including the first and second transmit antenna slots and at least one second double slot antenna including the first and second receive antenna slots.

15. A vehicle comprising the radar sensor system of claim 14, wherein the plurality of double slot antennas are arranged on an exterior of the vehicle.

16. The radar sensor system of claim 1, further comprising a vehicle control system configured to control at least one function of a vehicle based on the detection of the object as performed by the radar sensor system.

17. The radar sensor system of claim 1, further comprising a driver alert system configured to generate an alert for a driver of a vehicle based on the detection of the object as performed by the radar sensor system.

18. A method of operating a radar sensor system, the method comprising:
respectively providing a source signal to first and second transmit antenna slots;
selectively shifting a phase of the source signal as provided to the second antenna slot relative to the source signal as provided to the first transmit antenna slot;
outputting transmit signals to an environment based on the source signal provided to the first and second antenna slots;
receiving, via first and second receive antenna slots, reflected signals corresponding to the transmit signals as reflected from an object in the environment;
in a first antenna pattern mode, summing the reflected signals;
in a second antenna pattern mode, calculating a difference between the reflected signals, and
detecting the object based on the sum of the reflected signals and the calculated difference between the reflected signals.

19. The method of claim 18, wherein:
the first antenna pattern mode corresponds to a common antenna pattern mode and the second antenna pattern mode corresponds to a differential antenna pattern mode;
in the common antenna pattern mode, the phase of the source signal as provided to the second transmit antenna slot is not shifted; and
in the differential antenna pattern mode, the phase of the source signal as provided to the second transmit antenna slot is shifted.

20. The method of claim 19, further comprising alternating between the common antenna pattern mode and the differential antenna pattern mode.
